(19) United States
(12) Patent Application Publication
(10) Pub. No.: US 2021/0252684 A1
(43) Pub. Date: Aug. 19, 2021

(54) Multipurpose Tool

(71) Applicant: Aaron Sagarese, Pearl City, HI (US)

(72) Inventor: Aaron Sagarese, Pearl City, HI (US)

(21) Appl. No.: 17/144,234

(22) Filed: Jan. 8, 2021

Related U.S. Application Data
(60) Provisional application No. 62/977,376, filed on Feb. 16, 2020.

(51) Int. Cl. B25D 1/04; B25D 1/06; B25F 1/00; B25G 1/10

(52) U.S. Cl. CPC B25D 1/045; B25G 1/10; B25F 1/006; B25D 1/06

(57) ABSTRACT

A multipurpose hammer tool with a balanced weight. The multipurpose hammer comprises a lighter weight head attached to one end of an ergonomically configured handle. A foot claw is attached to the opposite end of the ergonomically configured handle. The foot claw is weighted to balance the weight of the multipurpose hammer so that the head may be lighter requiring less force to swing the hammer. The foot claw is curved to pull out nails with leverage. The head comprises a hexagonal face for striking nails with a pair of magnetic nail catches on the top and bottom. A foot claw end of the head has straight tines for pulling nails close to a wall or corner where a curved claw would not fit.

### CROSS-REFERENCE TO RELATED APPLICATION

The present application claims priority to, and the benefit of, U.S. Provisional Application No. 62/977,376, which was filed on Feb. 16, 2020 and is incorporated herein by reference in its entirety.

### BACKGROUND

The present invention generally relates to a multipurpose tool, and more specifically to a reconfigured hammer with an ergonomic design and additional functionality. Accordingly, the present specification makes specific reference thereto. However, it is to be appreciated that aspects of the present invention are also equally amenable to other like applications, devices and methods of manufacture.

A hammer is a tool with a weighted head attached or affixed to a handle that is swung to deliver an impact to a relatively small area of an object. Hammers have a wide variety of designs and are configured to accomplish a wide variety of driving, shaping, and breaking applications. Hammers are used every day in a wide variety of applications, especially by professionals. The traditional hammer design has an uneven weight distribution where most of the weight is located in the head of the hammer. This makes swinging more difficult and allows for less accuracy when striking a nail. It can be difficult to strike nails in various positions with optimal control and efficiency using a conventionally designed hammer.

The most commonly used hammer is the claw hammer. While many hammers only perform the driving or pounding function, claw hammers are additionally configured as a prying tool to pull things apart or remove nails. Thus, the claw hammer is a multifunctional tool that both hammers and pries. The curved claw hammer contains a double-sided head that lets you drive nails into surfaces using the hammer side and remove nails using the curved claw side of the head. This hammer is split and usually curved on the claw side forming a cleft for engaging a nail to be pulled out. The claw is generally rounded allowing for better leverage as the used pulls the handle. The hammer side of the head also is slightly curved to minimize marring the surface you are nailing. The flat side is used to pound nails in.

Claw hammers have been further modified to better perform many different functions. The straight claw hammer, also known as a ripping claw hammer, is used to dismantle items, including wood, tile and plastic. The hammer's claw is not curved and fits between boards and materials to separate them without the hassle of using another tool. Straight claw hammers are heavier than curved claw hammers. Traditional framing or ripping hammers feature a slightly curved, dull claw on the head designed for splitting wood in rough-framing applications. Framing hammers do not contain a curved head, which also leads to indentations in the wood or other surface you are nailing.

In this manner, the improved multipurpose tool of the present invention accomplishes all of the forgoing objectives, thereby providing an easy solution for overcoming the deficiencies of conventional hammers. A primary feature of the present invention is a hammer with an ergonomically correct design that offers ease of use for carpenters, contractors, plumbers, electricians, laborers, or anyone else that uses a hammer. The design enables users to operate the hammer with less manual effort than conventional hammers affording users the ability to strike nails at any angle with ease and accuracy. The new design of the present invention also features a redesigned claw that comes to a point for easy use and maximum efficiency in these various applications.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a multipurpose hammer. The multipurpose hammer comprises a handle, a head, and a foot claw. The head is attached to a head engaging portion of the handle at one end of the handle. The foot claw is attached to a foot claw engaging portion of the handle at an opposing end of the handle. The handle is ergonomically curved and can be one solid piece comprising the head, handle and bottom claw.

The head comprises a face end, a body, and a claw end. The face end comprises a hexagonal face. A first nail catch is formed into a top side of the face end and a second nail catch is formed into a bottom side of the face end. The claw end comprises a pair of straight projecting tines extending out from the body with a notch in between. The body comprises a nail pulling element laterally disposed on a top side of the body. The head is secured to the handle with a head securing element laterally penetrating the body and the head engaging portion of the handle.

The foot claw may be weighted to balance the multipurpose hammer. The foot claw comprises a sleeve that fits over the foot engaging portion of the handle. A plurality of teeth on an interior of the sleeve grip the foot claw engaging portion of the handle further securing the foot claw to the handle. A foot claw securing element further secures the foot claw to the foot claw engaging portion of the handle laterally penetrating the sleeve and the foot claw engaging portion of the handle. The foot claw further comprises a pair of curved projecting tines extending out from the sleeve with a notch in between.

The subject matter disclosed and claimed herein, in another embodiment thereof, comprises a multipurpose hammer. The multipurpose hammer comprises a handle, a head, and a foot claw. The head is attached to a head engaging portion of the handle at one end of the handle. The foot claw is attached to a foot claw engaging portion of the handle at an opposing end of the handle. The handle is ergonomically curved.

The head comprises a face end, a body, and a claw end. The face end comprises a hexagonal face. A first nail catch is formed into a top side of the face end and a second nail catch is formed into a bottom side of the face end. The claw end comprises a pair of straight projecting tines extending out from the body with a notch in between. The body comprises a nail pulling element laterally disposed on a top side of the body. The head is secured to the handle with a head securing element laterally penetrating the body and the head engaging portion of the handle.

The foot claw may be weighted to balance the multipurpose hammer. The foot claw comprises a rod for engaging a bore vertically disposed in the foot claw engaging portion of the handle. Once the rod is located within the bore, a plurality of securing bands surround the foot claw engaging portion of the handle with the rod to further secure the foot claw to the handle. The foot claw further comprises a pair of curved projecting tines extending out from the sleeve with a notch in between.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side perspective view of one embodiment of a multipurpose hammer of the present invention in accordance with the disclosed architecture.

FIG. 2 illustrates a side perspective view of a head of the multipurpose hammer of the present invention in accordance with the disclosed architecture.

FIG. 3 illustrates a front perspective view of the head of the multipurpose hammer of the present invention in accordance with the disclosed architecture.

FIG. 4 illustrates an end view of the head of the multipurpose hammer of the present invention in accordance with the disclosed architecture.

FIG. 5 illustrates an exploded view of the head engaging a handle of the multipurpose hammer of the present invention in accordance with the disclosed architecture.

FIG. 6 illustrates a side view of the head of the multipurpose hammer of the present invention in accordance with the disclosed architecture.

FIG. 7 illustrates an exploded view of a foot claw engaging the handle of the multipurpose hammer of the present invention in accordance with the disclosed architecture.

FIG. 8 illustrates a perspective view of a claw end of the head of the multipurpose hammer of the present invention pulling a nail in accordance with the disclosed architecture.

FIG. 9 illustrates a perspective view of a first nail catch of a face end of the head of the multipurpose hammer of the present invention holding a nail in accordance with the disclosed architecture.

FIG. 10 illustrates a side perspective view of one embodiment of a multipurpose hammer of the present invention in accordance with the disclosed architecture.

FIG. 11 illustrates an exploded view of a foot claw engaging a handle of the multipurpose hammer of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, is a hammer with weight distributed substantially equally due to a curved handle and a heavily curved claw on the bottom. The uniquely designed tool allows users to swing it almost effortlessly due to the weight distribution between the bottom and the top. The bottom claw enables users to pull nails without the need for a nail puller or other additional tools in most scenarios.

The hammer is comprised of a solid piece of metal that forms a head of the hammer. The metal head is substantially hexagonal in shape and mildly rounded on all of the edges of the face. The head is not rounded or square like traditional hammers. The head may be compressed onto a wooden, fiberglass, solid metal construction, or composite shock absorbent handle and further secured with a grade eight double-sided sleeved screw or bolt in one embodiment. This helps hold the head in place on the handle without loosening. The handle may be aggressively curved.

The hammer may further comprise an additional claw built in or attachable to a bottom of the handle. The additional claw balances the weight of the hammer and allows the weight of the head to be lighter than that of a traditional hammer. The additional claw may be weighted and built as an internal shaft inside of the handle secured by steel belts to prevent it from being pulled out in one embodiment. In another embodiment, the additional claw may be configured with a sleeve that fits over a bottom of the handle with small teeth from front to back holding it in place. The additional claw may be also be further secured with a double sided screw similar to the grade eight double-sided sleeved screw or bolt used to secure the head of the hammer at the opposite end of the handle, or constructed of one solid piece that includes the head, handle and the claw.

The hammer may further comprise a pair of magnetic nail catches on a bottom and a top of the head. A top of the hammer may employ a straight claw with built-in nail puller configured to get flush with a wall or corner to engage a nail. The bottom claw allows for weight distribution and allows users to get into tight places with additional leverage.

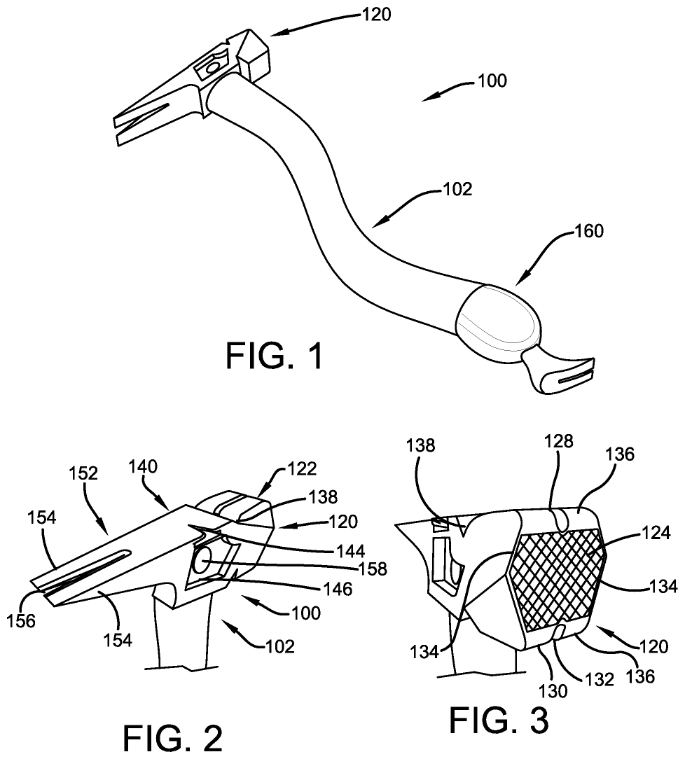

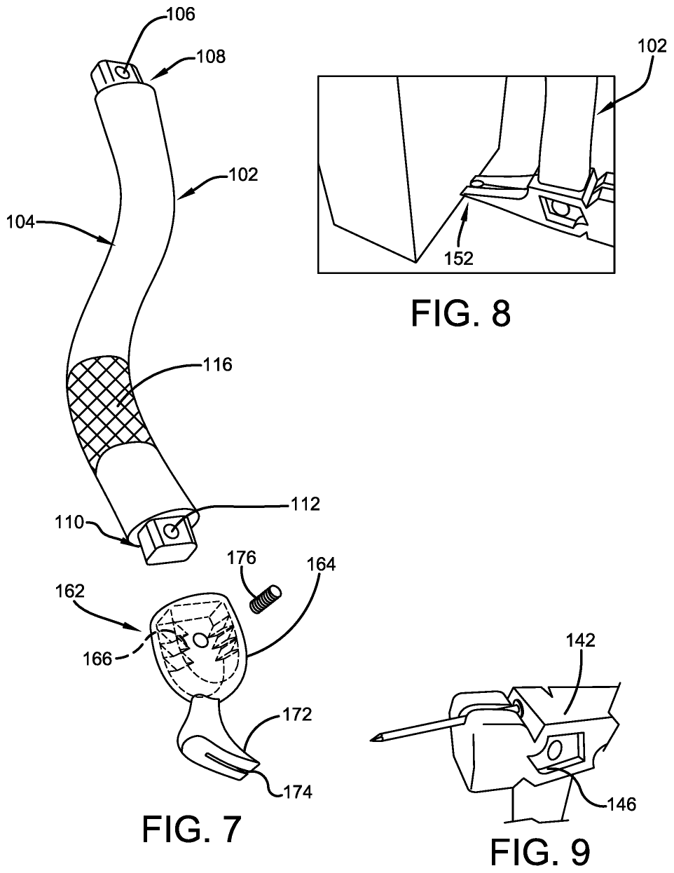

Referring initially to the drawings, FIG. 1 illustrates a multipurpose hammer 100. The multipurpose hammer 100 comprises a handle 102, a head 120, and a foot claw 160. The handle 102 may be manufactured from wood, metal, fiberglass, plastic, composite material, or any similar shock absorbing material. As further illustrated in FIG. 7, the handle 102 comprises a head engaging portion 106, a foot claw engaging portion 110, and a curved portion 104 connecting the head engaging portion 106 and the foot claw engaging portion 110. The curved portion 104 is ergonomically curved for comfort and functionality. The handle may further comprise a grip 116 covering a portion of the curved portion 104.

The head 120 is attached to the head engaging portion 106 of the handle 102 at one end of the handle 102. The head engaging portion 106 comprises a lateral through hole 108 for forming a connection with the head 120 as described infra. The foot claw 160 is attached to the foot claw engaging portion 110 of the handle 104 at an opposing end of the handle 104. The foot claw engaging portion 110 may similarly comprise a lateral through hole 112 for forming a connection with the foot claw 160 as described infra. In one embodiment of the present invention, the entire multipurpose hammer 100 is of unitary construction of a single material.

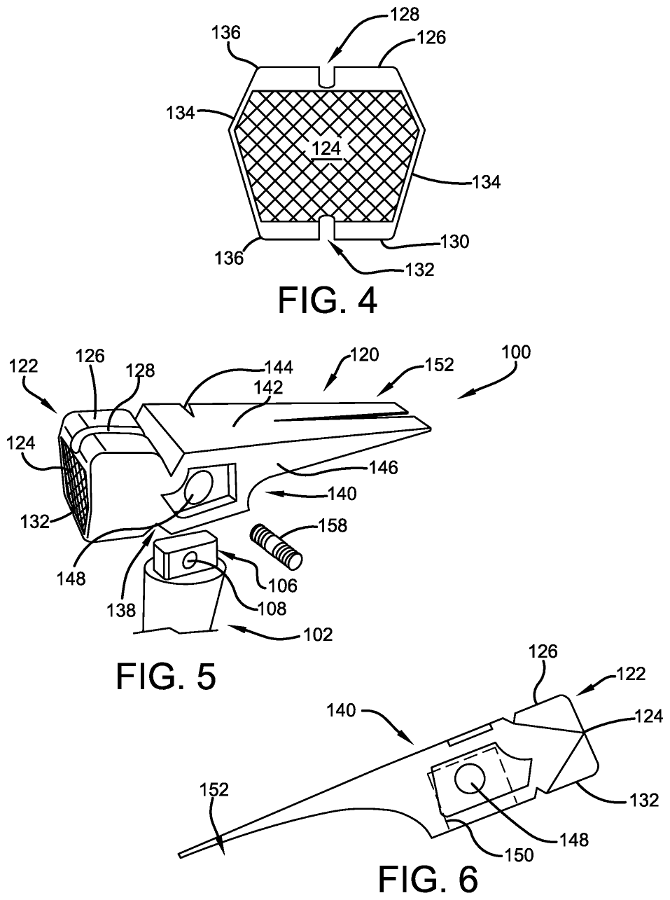

As illustrated in FIGS. 2-6, the head 120 comprises a face end 122, a body 140, and a claw end 152. The head 120 is typically manufactured from a solid piece of metal. The face end 122 comprises a hexagonal face 124 defined by a top side 126, a bottom side 130, and a pair of angled sides 134 connecting the top and bottom sides 126 and 130. All of the sides 126, 130, and 134 are joined by rounded edges 136. A first nail catch 128 is formed into the top side 126 of the face end 122. The first nail catch 128 is a groove running from the hexagonal face 124 into a neck 138 of the head 120. The first nail catch 128 may be magnetic so as to hold a nail as illustrated in FIG. 9. A second mail catch 132 is formed into the bottom side 126 of the face end 122. The second nail catch 132 is a groove running from the hexagonal face 124 into the neck 138 of the head 120 substantially parallel to the first nail catch 128. The second nail catch 132 is also magnetic.

The body 140 extends between the neck 138 and the claw end 152. The body 140 comprises a top side 142, a cheek 146, and a handle bore 150. The cheek 146 may be indented to reduce weight and comprises a head securing hole 148 laterally penetrating the cheek 146. The head engaging portion 106 of the handle 102 fits into the handle bore 150 so that the lateral through hole 108 of the head engaging portion 106 of the handle 102 substantially aligns with the head securing hole 148 of the cheek 146. The head 120 is then securable to the handle 102 with a head securing element 158 as illustrated in FIG. 5. The head securing element 158 is a mechanical fastener that attaches and secured the head 120 to the handle 102 through both the head securing hole 148 and the lateral through hole 108. The head securing element 158 may be a double sided screw similar to the grade eight double-sided sleeved screw or bolt, or the like.

The body 140 may further comprise a lateral nail pulling element 144. The lateral nail pulling element 144 extends from the top side 142 with an opening configured to receive and engage a nail head from the side of the multipurpose hammer 100. This allows the multipurpose hammer 100 to pull nails that are up against a wall or surface that could not be engaged by the claw end 152 or the foot claw 160.

The claw end 152 comprises a pair of straight projecting tines 154 extending out from the body 140 with a notch 156 for engaging a nail in between. The pair of straight projecting tines 154 are substantially in line with and extend from the top side 142 of the body 140. As illustrated in FIG. 8, the pair of straight projecting tines 154 allows the multipurpose hammer 100 to pull nails that are up against a wall or surface that could not be engaged by the lateral nail pulling element 144 or the foot claw 160.

As illustrated in FIGS. 1 and 7, the foot claw 160 may be weighted to balance the multipurpose hammer 100. The foot claw 160 comprises a handle engaging portion 162. The handle engaging portion 162 comprises a sleeve 164 that fits over the foot claw engaging portion 110 of the handle 102. A plurality of teeth 166 on an interior of the sleeve 164 grip the foot claw engaging portion 110 of the handle 102 further securing the foot claw 160 to the handle 102.

A foot claw securing element 176 may further secures the foot claw 160 to the foot claw engaging portion 110 of the handle 102 laterally penetrating the sleeve 164 and the foot claw engaging portion 110 of the handle 102. The foot claw securing element 176 is a mechanical fastener, similar to the head securing element 158, that attaches and secured the foot claw 160 to the handle 102 through a through hole in the sleeve 164 the lateral through hole 112 of the foot claw engaging portion 110 of the handle 102. The foot claw securing element 176 may be a double sided screw similar to the grade eight double-sided sleeved screw or bolt, or the like. The foot claw 160 further comprises a pair of curved projecting tines 172 extending out from the sleeve 164 with a notch 174 in between. The pair of curved projecting tines 172 are configured to allow the user to exert additional leverage when pulling nails.

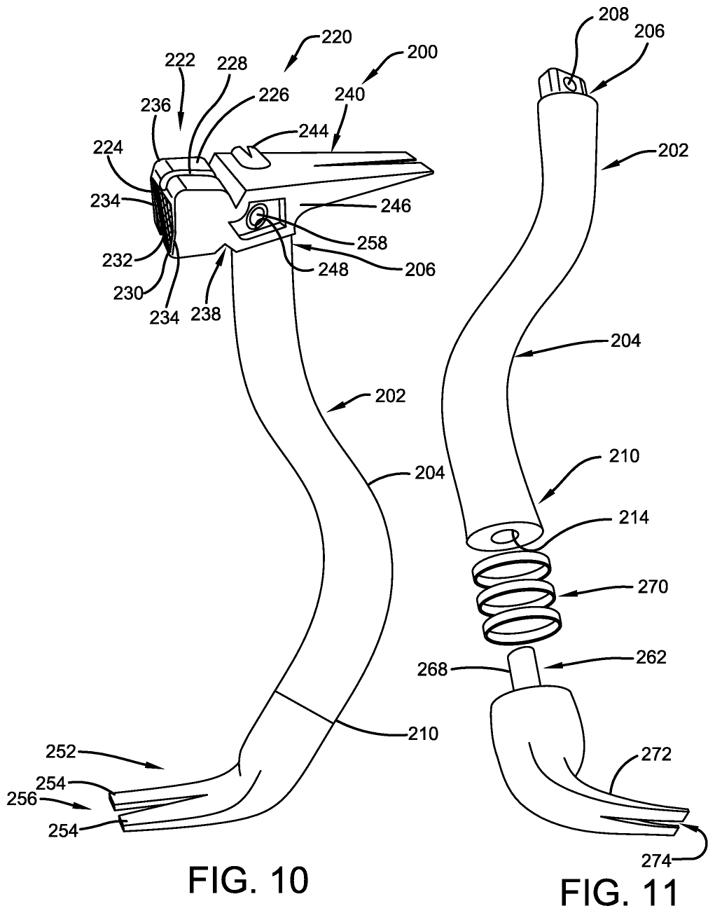

In an additional embodiment as illustrated in FIGS. 10 and 11, a multipurpose hammer 200 comprises a handle 202, a head 220, and a foot claw 260. The handle 202 comprises a head engaging portion 206, a foot claw engaging portion 210, and a curved portion 204 connecting the head engaging portion 206 and the foot claw engaging portion 210. The curved portion 204 is ergonomically curved for comfort and functionality.

The head 220 is attached to the head engaging portion 206 of the handle 202 at one end of the handle 202. The head engaging portion 206 comprises a lateral through hole 208 for forming a connection with the head 220 as described infra. The foot claw 260 is attached to the foot claw engaging portion 210 of the handle 204 at an opposing end of the handle 204. The foot claw engaging portion 210 comprises a vertical bore 214 for forming a connection with the foot claw 160 as described infra.

The head 220 comprises a face end 222, a body 240, and a claw end 252. The face end 222 comprises a hexagonal face 224 defined by a top side 226, a bottom side 230, and a pair of angled sides 234 connecting the top and bottom sides 226 and 230. All of the sides 226, 230, and 234 are joined by rounded edges 236. A first nail catch 228 is formed into the top side 226 of the face end 222. The first nail catch 228 is a groove running from the hexagonal face 224 into a neck 238 of the head 220. The first nail catch 228 may be magnetic so as to hold a nail. A second nail catch 232 is formed into the bottom side 226 of the face end 222. The second nail catch 232 is a groove running from the hexagonal face 224 into the neck 238 of the head 220 substantially parallel to the first nail catch 228. The second nail catch 232 is also magnetic.

The body 240 extends between the neck 238 and the claw end 252. The body 240 comprises a top side 242, a cheek 246, and a handle bore (similar to 150). The cheek 246 may be indented to reduce weight and comprises a head securing hole 248 laterally penetrating the cheek 246. The head engaging portion 206 of the handle 202 fits into the handle bore so that the lateral through hole 208 of the head engaging portion 206 of the handle 202 substantially aligns with the head securing hole 248 of the cheek 246. The head 220 is then securable to the handle 202 with a head securing element 258. The head securing element 258 is a mechanical fastener that attaches and secured the head 220 to the handle 202 through both the head securing hole 248 and the lateral through hole 208. The body 240 may further comprise a lateral nail pulling element 244. The lateral nail pulling element 244 extends from the top side 242 with an opening configured to receive and engage a nail head from the side of the multipurpose hammer 200.

The claw end 252 comprises a pair of straight projecting tines 254 extending out from the body 240 with a notch 256 for engaging a nail in between. The pair of straight projecting tines 254 are substantially in line with and extend from the top side 242 of the body 240.

As illustrated in FIG. 11, the foot claw 260 may be weighted to balance the multipurpose hammer 200. The foot claw 260 comprises a handle engaging portion 262. The handle engaging portion 262 comprises a rod 268 for engaging the bore 214 vertically disposed in the foot claw engaging portion 210 of the handle 202. Once the rod 268 is located within the bore 214, a plurality of securing bands 270 are positioned to surround the foot claw engaging portion 210 of the handle 202 with the rod 268 and tightened to further secure the foot claw 260 to the handle 202. The foot claw 260 further comprises a pair of curved projecting tines 272 extending out from the handle engaging portion 262 with a notch 274 in between.

The hammer may be comprised of any single material or combination of materials that are designed to increase strength, longevity, functionality, and ease of use and may include, without limitation, wood, fiberglass, resins, composite materials, carbon fiber, high carbon steel, titanium and combinations thereof. For example, one embodiment of the hammer may be comprised entirely of titanium.

It is contemplated that the multipurpose hammer 100 and 200 constructed in accordance with the present invention will be tailored and adjusted by those of ordinary skill in the art to accommodate various levels of performance demand imparted during actual use. Accordingly, while this invention has been described by reference to certain specific embodiments and examples, it will be understood that this invention is capable of further modifications. This application is, therefore, intended to cover any variations, uses or adaptations of the invention following the general principles thereof, and including such departures from the present disclosure as come within known or customary practice in the art to which this invention pertains and fall within the limits of the appended claims.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A multipurpose hammer comprising:
a handle;
a head attached to a head engaging portion of the handle; and
a foot claw attached to a foot claw engaging portion of the handle.

2. The multipurpose hammer of claim 1, wherein the handle is curved.

3. The multipurpose hammer of claim 1, wherein the head comprises a face end comprising a hexagonal face.

4. The multipurpose hammer of claim 1, wherein the head comprises a claw end comprising a pair of straight projecting tines.

5. The multipurpose hammer of claim 1, wherein the head is secured to the handle with a head securing element laterally penetrating a body of the head.

6. The multipurpose hammer of claim 1, wherein the foot claw comprises a sleeve that fits over foot claw engaging portion of the handle.

7. The multipurpose hammer of claim 1, wherein the foot claw comprises a pair of curved projecting tines.

8. The multipurpose hammer of claim 1, wherein the foot claw is weighted to balance the multipurpose hammer.

9. A multipurpose hammer comprising:
a curved handle;
a head attached to a head engaging portion of the handle, the head comprising a claw end comprising a pair of straight projecting tines; and
a foot claw attached to a foot claw engaging portion of the handle, the foot claw comprising a pair of curved projecting tines.

10. The multipurpose hammer of claim 9, wherein the foot claw comprises a sleeve that fits over foot claw engaging portion of the handle.

11. The multipurpose hammer of claim 10, wherein the sleeve comprises a plurality of teeth for engaging the foot claw engaging portion of the handle and securing the foot claw to the curved handle.

12. The multipurpose hammer of claim 9, wherein the foot claw is weighted to balance the multipurpose hammer.

13. The multipurpose hammer of claim 9, wherein the head further comprises a face end comprising a hexagonal face.

14. The multipurpose hammer of claim 13, wherein the face end further comprises at least one nail catch formed into the face end.

15. The multipurpose hammer of claim 14, wherein the at least one nail catch is magnetic.

16. The multipurpose hammer of claim 9, wherein the head is secured to the handle with a head securing element laterally penetrating a body of the head.

17. The multipurpose hammer of claim 9, wherein the head further comprises a body comprising a nail pulling element extending laterally from a top side of the body.

18. A multipurpose hammer comprising:
a handle;
a head attached to a head engaging portion of the handle, the head comprising a claw end comprising a pair of straight projecting tines; and
a foot claw attached to a foot claw engaging portion of the handle, the foot claw comprising a pair of curved projecting tines and a rod for engaging a bore in the foot claw engaging portion of the handle.

19. The multipurpose hammer of claim 18, wherein the foot claw is further secured to the handle with a plurality of bands.

20. The multipurpose hammer of claim 19, wherein the handle is curved.
